(19) United States
(12) Patent Application Publication
(10) Pub. No.: US 2019/0126709 A1
(43) Pub. Date: May 2, 2019

(54) LIFT KIT

(71) Applicant: Pilot Inc., City of Industry, CA (US)

(72) Inventor: Kelleigh Ash, City of Industry, CA (US)

(21) Appl. No.: 16/172,335

(22) Filed: Oct. 26, 2018

Related U.S. Application Data
(60) Provisional application No. 62/578,917, filed on Oct. 30, 2017.

(51) Int. Cl. B60G 15/06; B60G 11/14; F16F 9/56

(52) U.S. Cl. CPC B60G 15/063; B60G 11/14; B60G 2204/1242; B60G 2500/30; B60G 2202/312; F16F 9/56

(57) ABSTRACT

A lift kit having front and rear coils improves the post-installation handling characteristics of a vehicle on which the lift kit is installed.

### CROSS REFERENCE TO RELATED APPLICATIONS

This application claims priority, and the benefit under 35 U.S.C. § 119(e), to U.S. Provisional Application Ser. No. 62/578,917, filed on Oct. 30, 2017 and entitled “Lift Kit,” which is incorporated by reference in its entirety.

### FIELD OF THE DISCLOSURE

The present disclosure relates to lift kits, and more particularly to lift kits having a front and rear coil.

### BACKGROUND

Suspension lift kits are useful for increasing a vehicle's ground clearance, while also changing the aesthetic appearance of the vehicle and allowing the installation of taller tires thereon. Such lift kits, which are typically provided as an aftermarket modification for a vehicle, affect the performance of the vehicle by, among other things, changing the vehicle's handling characteristics.

### SUMMARY

Aftermarket lift kits typically have a negative impact on vehicle handling and other performance characteristics. According to some embodiments of the present disclosure, a lift kit is provided with both front and rear coils. The inclusion of front and rear coils reduces the negative impact of the lift kit (once installed) on vehicle handling characteristics. Other aspects of embodiments of the present disclosure also beneficially reduce the negative impact of the lift kit on vehicle handling characteristics. As a result, lift kits according to embodiments of the present disclosure beneficially improve the post-installation handling of vehicles on which the lift kits are installed.

A lift kit according to one embodiment of the present disclosure comprises: a front coil lift kit and a rear coil lift kit. The front coil lift kit comprises driver side front coil-over shock and a passenger side front coil-over shock; and a driver side front coil spring and a passenger side front coil spring. The rear coil lift kit comprises a driver side rear coil-over shock and a passenger side rear coil-over shock; and a driver side rear coil spring and a passenger side rear coil spring.

Aspects of the above lift kid include: a pair of sway bar end links, a sway bar, at least one upper knuckle and at least one lower knuckle, a first front arm bar, a first transfer case, a second front arm bar, and a second transfer case; wherein the first front arm bar is between about 25 inches and about 29 inches in length, the second front arm bar is between about 34 inches and about 38 inches in length; a first rear trailing arm bar, a second rear trailing arm bar, and a rear Panhard bar; wherein the first rear trailing arm bar is between about 22 inches and about 26 inches in length, the second rear trailing arm bar is between about 34 inches and about 38 inches in length, and the rear Panhard bar is between about 29 inches and about 32 inches in length; and wherein the driver side front coil spring, the passenger side front coil spring, the driver side rear coil spring, and the passenger side rear coil spring are each about 10-inches or about 12-inches in length.

A method of installing a lift kit according to another embodiment of the present disclosure comprises: installing a front spring over a front coil-over shock; attaching the front coil-over shock to a front axle of a vehicle; connecting a rear Panhard bar to a rear coil-over shock; installing a rear lower spring over a lower portion of the rear coil-over shock and a rear upper spring over an upper portion of the rear coil-over shock; and attaching the rear lower coil-over shock and the rear upper coil-over shock to a rear axle of a vehicle.

Aspects of the foregoing method comprise: installing a second front spring over a second front coil-over shock; attaching a second front coil-over shock to the front axle of the vehicle; installing a third rear spring over a second rear coil-over shock; attaching the second rear coil-over shock to the rear axle of the vehicle; wherein installing the front spring over the front coil-over shock comprises installing the front spring over a lower portion of the front coil-over shock and installing an upper front spring over an upper portion of the front coil-over shock; wherein one of the front spring and the upper front spring is about 10 inches in length; wherein the rear Panhard bar is about 29.5 inches in length; and wherein the front coil-over shock and the front spring increase a height of a front portion of a frame of the vehicle relative to the front axle of the vehicle, and the rear coil-over shock, the rear lower spring, and the rear upper spring increase a height of a rear portion of a frame of the vehicle relative to the rear axle of the vehicle.

A vehicle according to another embodiment of the present disclosure comprises: a frame; a front axle; a rear axle; a front coil lift kit comprising a driver side front coil-over shock and a passenger side front coil-over shock, the driver side front coil-over shock and the passenger side front coil-over shock each having a first end and a second end, wherein the first end is attached to the frame of the vehicle and the second end is attached to the front axle, and a pair of front coil springs, one of the pair installed over the driver side front coil-over shock and another of the pair installed over the passenger side front coil-over shock; and a rear coil lift kit comprising a driver side rear coil-over shock and a passenger side rear coil-over shock, the driver side rear coil-over shock and the passenger side rear coil-over shock each having a first end and a second end, wherein the first end is attached to the frame and the second end is attached to the rear axle, and a pair of rear coil springs, one of the pair of rear coil springs installed over the driver side rear coil-over shock and another of the pair installed over the passenger side rear coil-over shock; wherein the front coil lift kit and the rear coil lift kit support the frame above the front axle and the rear axle by at least 10 inches.

Aspects of the foregoing vehicle comprise: a pair of sway bar end links attached to the driver side front coil-over shock and the passenger side front coil-over shock; a sway bar attached to the pair of sway bar end links; at least one upper knuckle and at least one lower knuckle attached to the front axle; a first front arm bar connected to the upper knuckle and a transfer case, the transfer case located on a drive shaft; a second front arm bar connected to the lower knuckle and a transfer case; a plurality of rear coil springs installed over each of the driver side rear coil-over shock and the passenger side rear coil-over shock; wherein the front lift kit is configured to produce at least a minus 4-degree yoke angle, at least a minus 7-degree pinion angle, and at least a minus 3-degree drive shaft angle; a plurality of front coil springs installed over each of the driver side front coil-over shock and the passenger side front coil-over shock; wherein the front coil lift kit and the rear coil lift kit support the frame above the front axle and the rear axle by about 12-14 inches; and wherein each of the plurality of front coil springs and the plurality of rear coil springs is about 10 inches or about 12 inches in length.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Z₀, the phrase is intended to refer to a single element selected from X, Y, and Z, a combination of elements selected from the same class (e.g., X₁ and X₂) as well as a combination of elements selected from two or more classes (e.g., Y₁ and Z₀). The terms “DS” refers to the driver side, “PS” refers to passenger side, “LH” refers to left-hand side, and “RH” refers to the right-hand side. Furthermore, “OD” refers to the outside diameter, and “ID” refers to the inside diameter.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a perspective view of a vehicle without a lift kit installed;

FIG. 2 is a block diagram of a vehicle with a lift kit installed according to embodiments of the present disclosure;

FIG. 3 is a perspective view of a front coil lift kit according to embodiments of the present disclosure;

FIG. 4 is a perspective view of a rear coil lift kit according to embodiments of the present disclosure;

FIG. 5 is perspective view of a front coil-over shock and front coil spring according to embodiments of the present disclosure;

FIG. 6 is perspective view of a rear coil-over shock and rear coil spring according to embodiments of the present disclosure; and

FIG. 7 is a flow chart of a method according to embodiments of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

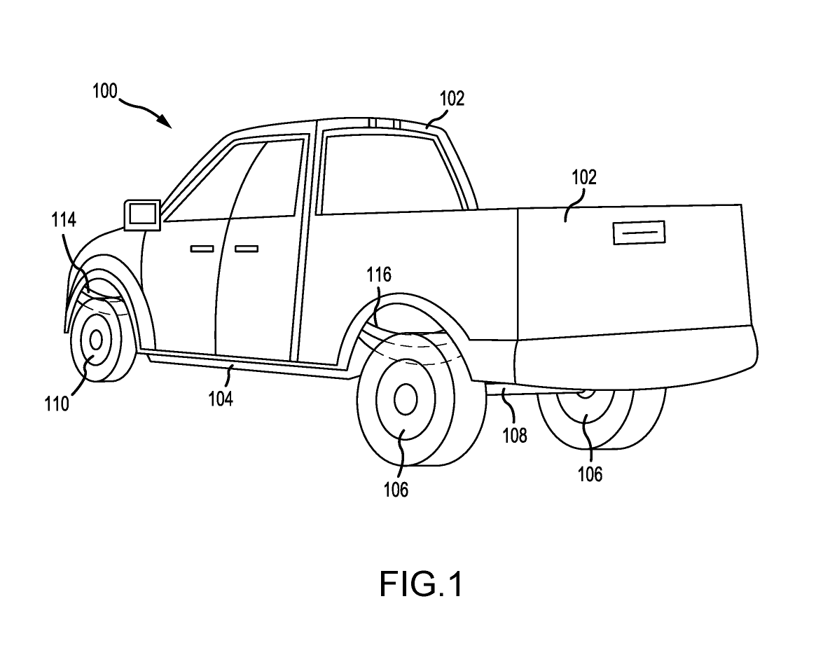

Referring first to FIG. 1, a vehicle 100 includes a body 102 that sits atop a frame 104. The rear wheels 106 are connected to a rear axle 108, and the front wheels 110 are connected to a front axle (not shown). A front suspension 114 is connected to the front wheels 110, and a rear suspension 116 is connected to the rear wheels 106.

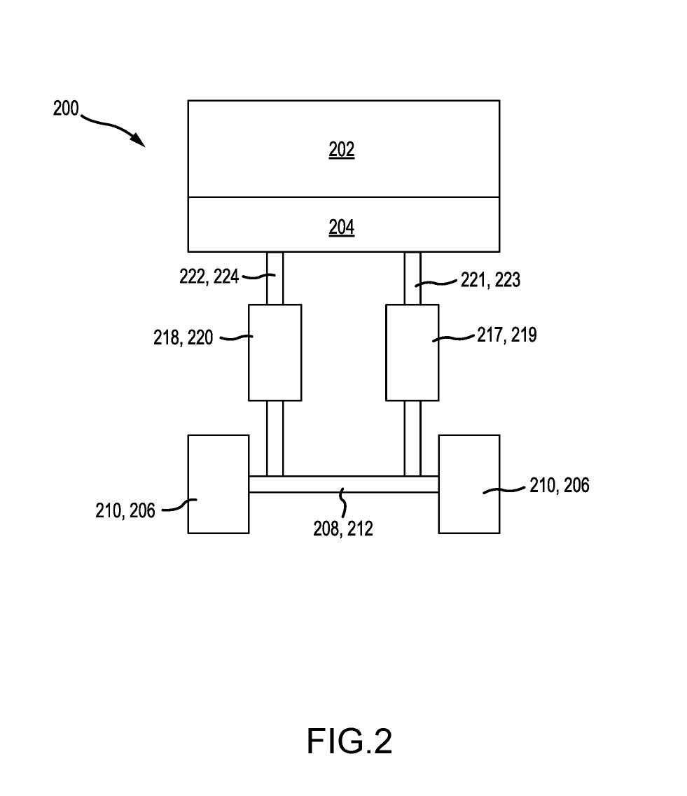

FIG. 2 depicts a vehicle 200 according to embodiments of the present disclosure. The diagram can be the front or the rear of the vehicle 200. The vehicle 200 includes a body 202 that sits atop a frame 204. In the front of the vehicle 200, the front wheels 210 are connected to a front axle 208. A driver side front coil spring 218 is installed over a driver side front coil-over shock 222, and a passenger side front coil spring 217 is installed over a passenger side front coil-over shock 221. The coil-over shocks 221, 222 of the vehicle 200 are connected to the front axle 208 at one end, and to the frame 204 at the other end. Thus, the driver side coil-over shock 222 connects to the front axle 208 and the frame 204. The passenger side front coil-over shock 221 also connects to the front axle 208 and the frame 204.

In the rear of the vehicle 200, the rear wheels 206 are connected to a rear axle 212. A driver side rear coil spring 220 is installed over a driver side rear coil-over shock 224, and a passenger side rear coil spring 219 is installed over a passenger side rear coil-over shock 223. The coil-over shocks 223, 224 of the vehicle 200 are connected to the rear axle 212 at one end, and to the frame 204 at the other end. The driver side rear coil-over shock 224 connects to the rear axle 212 and the frame 204. The passenger side rear coil-over shock 223 connects to the rear axle 212 and the frame 204.

In some embodiments of the present disclosure, the coil-over shocks 221, 222, 223 224 are hydraulic struts having between about 5 inches and about 8 inches of travel. In other embodiments, the coil-over shocks 221, 222, 223 224 are hydraulic struts having about 6.75-inches of travel. The coil-over shocks 221, 222, 223 224 may be monotube or twin tube struts. Furthermore, it will be understood that coil-over shocks other than hydraulic struts may be used. For example, the coil-over shocks 221, 222, 223 224 may be, in some embodiments, a solid bar constructed of metal, carbon fiber, or plastic polymer material.

Also, it will be understood that different coil-over shocks may be used in different positions. For example, a monotube hydraulic strut may be used for the front coil-over shocks 221, 223 on the front axle, and a shock mount made of a solid carbon fiber bar may be used for the rear coil-over shocks 223, 224 on the rear axle. It will be understood that all permutations of the above embodiments may be used within the scope of the present disclosure.

According to some embodiments of the present disclosure, the coil springs 217, 218, 219, 220 are metal coil springs between about 5 inches and about 15 inches in length. Between about 300 pounds and about 800 pounds of force are required to compress such springs 217, 218, 219, 220 one inch. In other, embodiments, the coil springs 217, 218, 219, 220 are metal coil springs between about 10 inches and about 14 inches in length. Between about 500 pounds and about 700 pounds of force are required to compress such springs 217, 218, 219, 220 one inch. In addition, multiple coil springs may be installed on a single coil-over shock 221, 222, 223, 224. For example, one spring that is 10 inches in length and compresses one inch under 550 pounds of force, and a second spring that is 12 inches in length and compresses one inch under 600 pounds of force, may be installed over the driver side front coil-over shock 222. In such an embodiment, there are two driver side front coil springs arranged end-to-end.

The coil-over shocks 221, 222, 223 224 and the coil springs 217, 218, 219, 220 may be installed as aftermarket parts in the place of original or previously installed suspension equipment, and may be configured to support the frame 204 higher above the ground by between about 12 inches and about 14 inches more than the original suspension equipment. In some embodiments, the coil-over shocks 221, 222, 223 224 and the coil springs 217, 218, 219, 220 may be configured to support the frame 204 about thirteen inches higher above the ground than the frame 204 was supported above the ground by original suspension equipment.

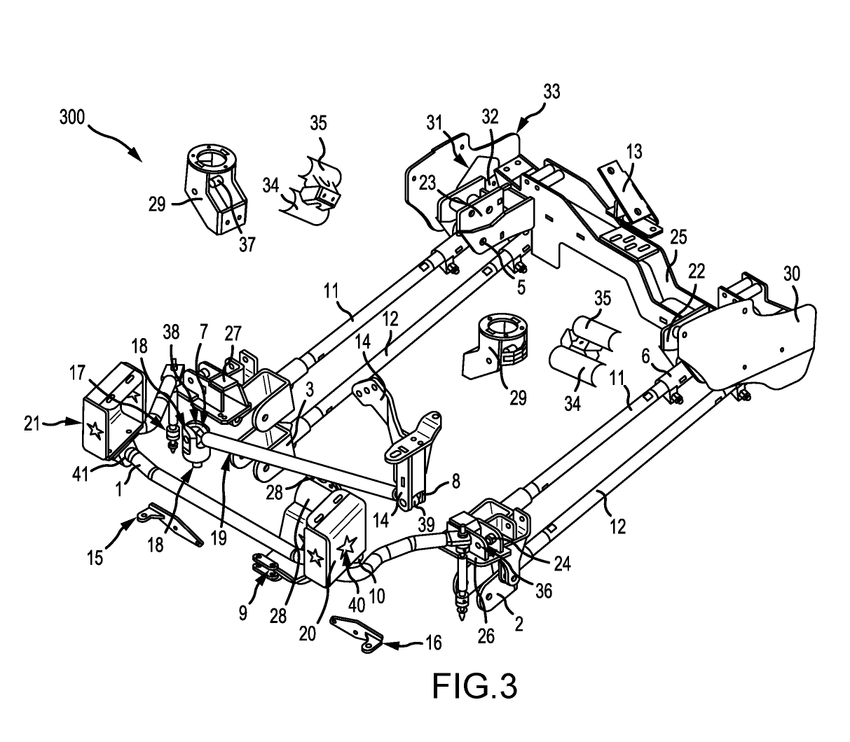

Referring now to FIG. 3, a front lift kit 300 for installation on a vehicle such as the vehicle 100 comprises a sway bar 1, a pair of DS knuckles 2, a pair of PS knuckles 3, a pair of spacers 5, a pair of upper and a pair of lower trailing arm knuckles 6 (for a total of four trailing arm knuckles 6), a pair of lower Panhard bar bushings 7, a pair of Heim spacers 8, a shock strap 9, a mounting ear spacer 10, a first pair of trailing arm bars 11, a second pair of trailing arm bars 12, a transfercase mounting bracket 13, a Panhard bar drop 14, a PS axle/shock mounting bracket 15, a DS axle/shock mounting bracket 16, a pair of sway bar end link assemblies 17, a lower Panhard bar mount 18, a Panhard bar 19, a DS front sway bar bracket 20, a PS front sway bar bracket 21, a DS transfercase crossmember mounting bracket 22, a PS transfercase crossmember mounting bracket 23, a pair of shock spacers 24, a transfercase crossmember 25, a DS lower axle/shock mount 26, a PS lower axle/shock mount 27, a steering stabilizer assembly 28, a pair of upper front coil-over shock mounts 29, a first plate 30, a pair of second plates 31, a pair of third plates 32, a fourth plate 33, a pair of front coil-over remote reservoir brackets 34, a pair of shock remote reservoir brackets 35, a pair of shock spacers 36, a two pairs of shock spacers 37, a first steel ball bearing 38, a second steel ball bearing 39, a dropped Pitman arm 40, and a pair of brackets 41 are shown.

The front lift kit 300 generally includes identical (or mirror-image) parts for the driver side and passenger side; accordingly, references to a “pair” of components above indicate that the same component is provided for both the driver side and the passenger side unless otherwise stated herein, even if only one such component is numbered and/or visible. The front lift kit 300 may be provided as a collection of some or all of the foregoing components. In some embodiments, the front lift kit 300 may comprise a plurality of subassemblies, each comprising two or more of the foregoing components operably connected to each other and ready for installation on a vehicle. In other embodiments, each of the components of the front lift kit 300 may be free-standing, such that each component must be individually installed on a vehicle. The front lift kit 300 may comprise other components not illustrated in FIG. 3, including other components discussed herein. For example, the front lift kit 300 also comprises a pair of coil-over shocks and a pair of coil springs.

The DS and PS front sway bar brackets 20 and 21 are each configured for attachment to the sway bar 1 via a bracket 41. Each end of the sway bar 1 is operably connected to a sway bar end link assembly 17. In some embodiments, there are first and second pairs of trailing arm bars 11 and 12, with each trailing arm bar 11 and 12 having a first and second end. The second end of each trailing arm bar 11 and 12 connects to an upper or lower trailing arm knuckle 6, respectively, and each trailing arm knuckle 6 also connects to the transfercase crossmember 25. The first end of each of the trailing arm bar 11 and the trailing arm bar 12 on the driver side connects to a DS knuckle 2, and the first end of each of the trailing arm bar 11 and the trailing arm bar 12 on the passenger side connects to a PS knuckle 3. The Panhard bar 19 connects to the front axle 212 of the vehicle 200 using the lower Panhard bar mount 18 at one end, and to the frame 204 using the Panhard bar drop 14.

In various embodiments, the spacer 5 may be a PHB spacer, which may be sized to accept about a ⅝-inch bolt. The Heim spacer 8 may have about an 0.880-inch inside diameter and about a 0.440-inch wide Heim spacer. The first trailing arm 11 may be about a 27-inch trailing arm. The second trailing arm 12 may be about a 36-inch trailing arm. The PS axle/shock mounting bracket 15 may be about 6.75 inches in length. The DS axle/shock mounting bracket 16 may be also about 6.75 inches in length. The sway bar attachment assembly 17 may include an about 6-inch sway bar end link with ball joint ends. The Panhard bar 19 may be about a 34-inch Panhard bar. The steering stabilizer assembly 28 may be a “K” steering stabilizer assembly. The first plate 30 may be a 7-gage DS cover with bends and includes a logo. The second plate 31 may be a 16-gage cover and includes a logo. The third plate 32 may be a 7-gage lift cover bracket with bends. The fourth plate 33 may be an 11-gage lift cover bracket with bends and a logo. The first and second ball bearings 38, 39 are PTFE-lined and about ⅞-inches in diameter.

The front lift kit 300 may be configured, according to some embodiments of the present disclosure, to yield (after installation of the front lift kit 300 into a vehicle) at least a minus 4-degree yoke angle, at least a minus 7-degree pinion angle, and at least a minus 3-degree drive shaft angle. The front lift kit 300 may also be configured to increase the height at which a front portion of a vehicle frame is supported above a ground-level reference point or plane by about 12 inches to about 14 inches, or by about 13 inches. For example, if the front lift kit 300 is installed on a vehicle in the place of originally installed front suspension equipment, the height of the frame of the vehicle above a ground-level reference point or plane with the front lift kit 300 installed may be about 12 inches to about 14 inches, or about 13 inches, higher than the height of the frame of the vehicle above the ground-level reference point or plane with the original front suspension equipment installed.

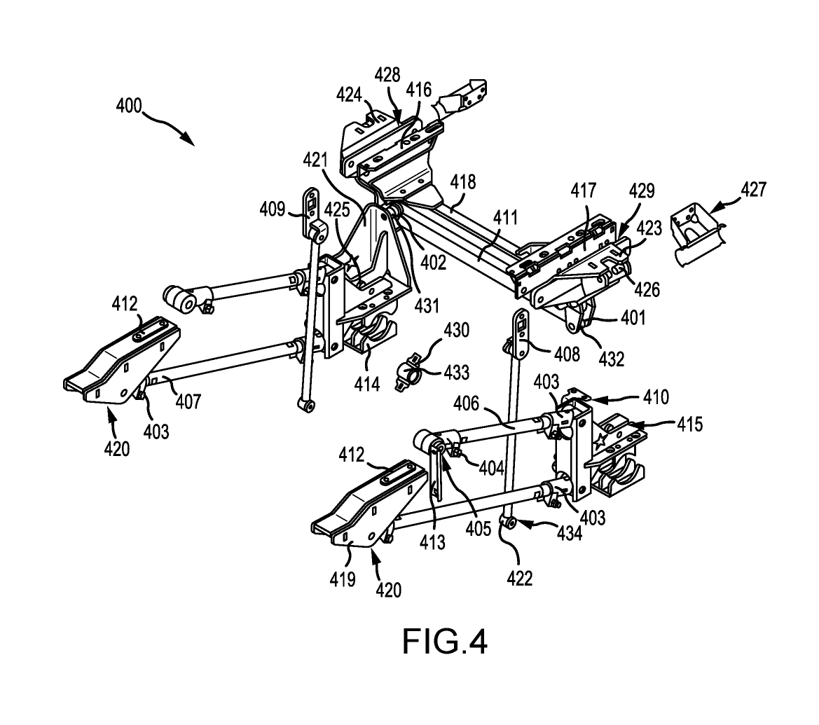

Referring now to FIG. 4, a rear lift kit 400 for installation on a vehicle such as the vehicle 100 comprises two pairs of Heim spacers 401, a pair of jam nuts 402, two pairs of trailing arm knuckles 403, two pairs of trailing arm knuckles 404, a pair of bushings 405, a first pair of trailing arm bars 406, a second pair of trailing arm bars 407, a DS end-link bracket 408, a PS end-link bracket 409, a brake line relocation bracket 410, a Panhard bar 411, a pair of perch mounting tabs 412, a first plate 413, a pair of axle mount assemblies 414, a DS lower coil-over shock/axle mount 415, a PS upper frame/shock mount 416, a DS upper frame/shock/Panhard bar mount 417, a rear crossmember 418, a pair of lower trailing arm/frame mounts 419, two pairs of second plates 420, a PS lower coil-over shock/axle/Panhard bar mount 421, a pair of end-links 422, a DS coil-over upper shock mount 423, a PS coil-over upper shock mount 424, a two pairs of shock spacers 425, two pairs of shock spacers 426, a pair of rear remote reservoir brackets 427, a third plate 428, a fourth plate 429, a pair of retainer rings 430, a ball joint rod end 431, a ball joint rod end 432, a pair of sway bar bushings 433, and a pair of washers 434 are shown.

The rear lift kit 400 generally includes identical (or mirror-image) parts for the driver side and passenger side; accordingly, references to a “pair” of components above indicate that the same component is provided for both the driver side and the passenger side unless otherwise stated herein, even if only one such component is numbered and/or visible. The rear lift kit 400 may be provided as a collection of some or all of the foregoing components. In some embodiments, the rear lift kit 400 may comprise a plurality of subassemblies, each comprising two or more of the foregoing components operably connected to each other and ready for installation on a vehicle. In other embodiments, each of the components of the rear lift kit 400 may be free-standing, such that each component must be individually installed on a vehicle. The rear lift kit 400 may comprise other components not illustrated in FIG. 4, including other components discussed herein. For example, the rear lift kit 400 also comprises a pair of coil-over shocks and a pair of coil springs.

The DS and PS end-link brackets 408 and 409 mount to the frame 204 of the vehicle 200. In some embodiments, the end-links 422 connect to the DS and PS end-link brackets 408 and 409, respectively. A rear sway bar (not shown) may connect to the pair of brackets 434 at the ends of the end-links 422. A rear crossmember 418 connects to the frame 204. The DS lower coil-over shock/axle mount 415 and the PS lower coil-over shock/axle/Panhard bar mount 421 are attached to the rear axle 208. In some embodiments, one end of each of the first and second pairs of trailing arm bars 406, 407 is connected via a trailing arm knuckle 403 to the DS lower coil-over shock/axle mount 415 (for the driver side trailing arm bars 406, 407) and to the PS lower coil-over shock/axle/Panhard bar mount 421 (for the passenger side trailing arm bars 406, 407). The other end of each of the trailing arm bars 406, 407 is connected via a trailing arm knuckle 404 to one of the pair of lower trailing arm/frame mounts 419, which pair of lower trailing arm/frame mounts 419 are attached to the frame 204.

According to some embodiments of the present disclosure, the Heim spacers 401 may be about 0.440-inch spacers. The jam nuts 402 may be about ¾-inch nuts. The bushings 405 may be bushings with about a 2-inch outer diameter by about a 0.875 inner diameter by about a 0.5625″ thickness. The trailing arm bar 406 may be about 24-inch arm bars. The trailing arm bars 407 may be about 36-inch arm bars. The Panhard bar 411 may be about a 30.5-inch bar. The first plate 413 may be an 11-gage plate with an e-brake relocation bracket and bend. The axle mount assemblies 414 may be axle mounts for about a 4-inch axle. The DS lower coil-over shock/axle mount 415 may be a 4-inch axle mount. The second plates 420 may be 11-gage plates. The PS lower coil-over shock/axle/Panhard bar mount 421 may be a 4-inch axle mount. The end-link 422 may be about 26-inch end-links. The third plate 428 and fourth plate 429 may be PS and DS ¼-inch, non-fifth wheel truck shim plates, respectively. The ball joint rod ends 431, 432 may be ¾-16-inch×¾ inch ball joint rod ends. The sway bar bushings 433 may be 4139-182KLD type bushings, and the washers 434 may have about a 1.5-inch outer diameter by about a 0.53-inch inner diameter with a thickness of about ¼-inch.

The rear lift kit 400 may also be configured to increase the height at which a rear portion of a vehicle frame is supported above a ground-level reference point or plane by about 12 inches to about 14 inches, or by about 13 inches. For example, if the rear lift kit 400 is installed on a vehicle in the place of originally installed rear suspension equipment, the height of the frame of the vehicle above a ground-level reference point or plane with the rear lift kit 400 installed may be about 12 inches to about 14 inches, or about 13 inches, higher than the height of the frame of the vehicle above the ground-level reference point or plane with the original rear suspension equipment installed.

As may be appreciated based on the present disclosure, while installation of a front lift kit 300 in a vehicle will increase the height of the front of the vehicle's frame, and installation of a rear lift kit 400 in a vehicle will increase the height of the rear of the vehicle's frame, installation of both a front lift kit 300 and a rear lift kit 400 in a vehicle will increase the height of the entire vehicle frame.

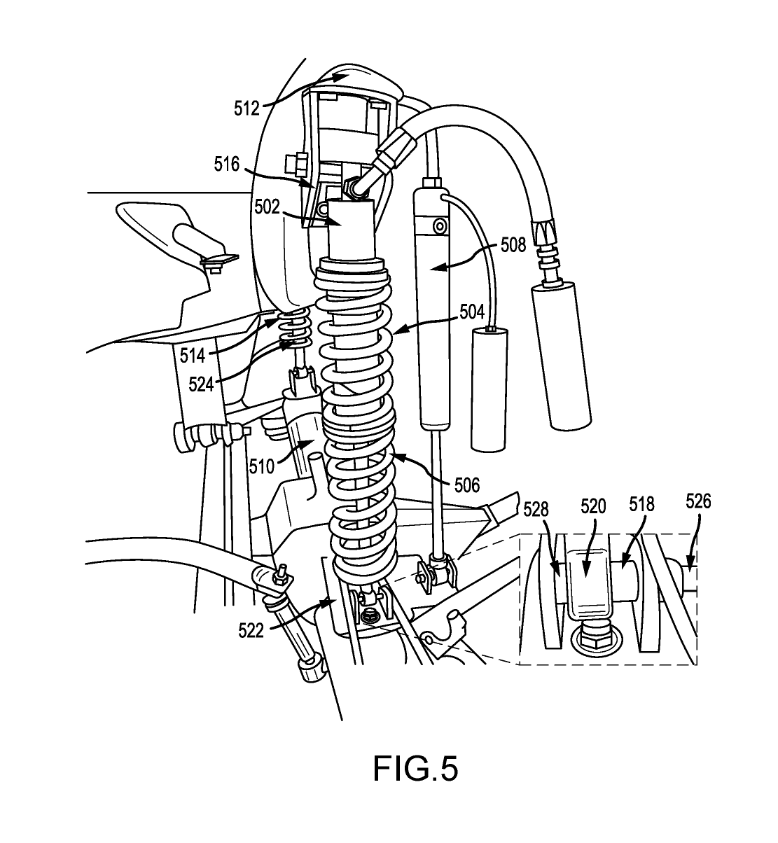

Referring now to FIG. 5, a driver side front coil-over shock 502 is connected to a front axle 510 by a bracket 522 and to a frame 512 by a bracket 516. According to some embodiments of the present disclosure, the shock 502 has a lower end 520 comprising an aperture. The shock 502 may be connected to the bracket 522 by passing a bolt 526 passing through the bracket 522 and the aperture of the lower end 520. A first spacer 528, which may be shorter than a second spacer 518, is installed over the bolt 526 on one side of the lower end 520 in between the lower end 520 and the bracket 522, and the second spacer 518 is installed over the bolt 526 in between the lower end 520 and the bracket 522 on the other side of the lower end 520 from the first spacer 528. The spacers 518, 528 may be rings, such that the bolt 526 passes through the spacers 518, 528 as well as the aperture 520 of the shock 502.

According to some embodiments of the present disclosure, an optional strut 508 is also connected to the front axle 510 and the frame 512. An upper front coil spring 504 is installed over an upper portion of the driver side front coil-over shock 502 and a lower front coil spring 506 is installed over a bottom portion of the driver side front coil-over shock 502. In FIG. 5, a passenger side front coil-over shock 524 is also visible with a passenger side front coil spring 514 installed over the passenger side front coil-over shock 524. The passenger side front coil-over shock 524 may be installed in the same manner at the driver side front coil-over shock 502. Moreover, even though only the coil spring 514 is visible over the passenger side front coil-over shock 524, a pair of coil springs (one of which is the coil spring 514) may be installed over the passenger side front coil-over shock 524 just as a pair of coil springs 504, 506 is installed over the driver side front coil-over shock 502. In other embodiments, however, only one coil spring may be installed over each of the driver side front coil-over shock and the passenger side front coil-over shock.

The depictions in FIG. 5 are not intended to be limiting. Variations of the shapes, configurations, and materials of the parts shown are encompassed by the present disclosure. For example, the coil springs 504, 506, 514 may be shorter or longer in length, and may have a larger or smaller diameter than the coil springs 504, 506, 514 shown in FIG. 5.

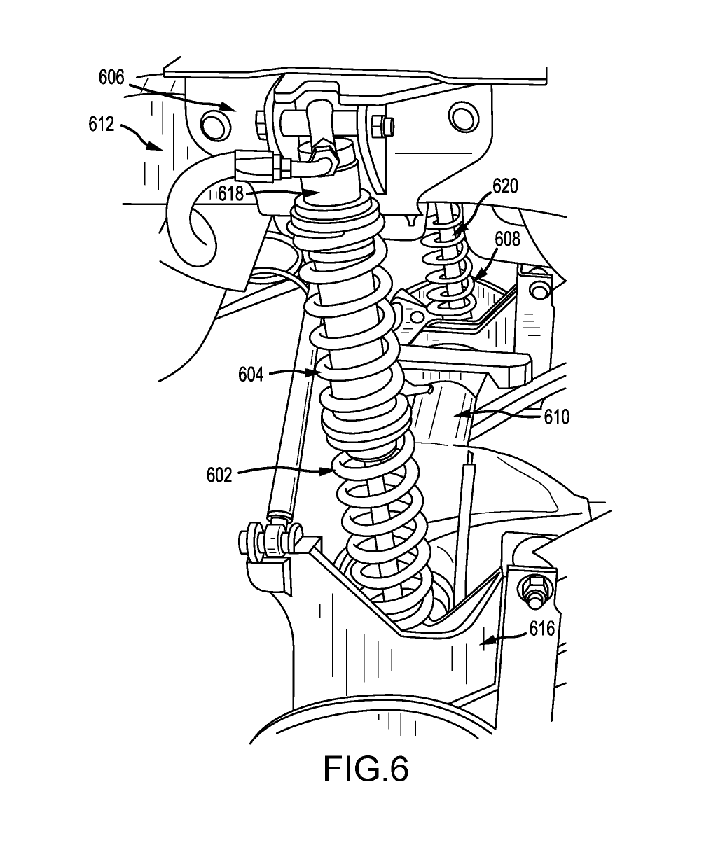

FIG. 6 depicts rear coil-over shocks 618, 620 according to some embodiments of the present disclosure. The passenger side rear coil-over shock 618 is connected to the rear axle 610 by the bracket 616, and the shock 618 is connected to the frame 612 by the bracket 606. The shock 618 may be mounted to the bracket 606 in the same manner as the shock 502 is mounted to the bracket 522, and the shock 620 may be mounted in the same manner to a bracket that is the same as, a mirror image of, or otherwise similar to the bracket 622. A first coil spring 602 is installed over a lower portion of the shock 618 and a second coil spring 604 is installed over an upper portion of the shock 618. Similarly, at least one coil spring 608 is installed over the driver side rear coil-over shock 620. In some embodiments, a single coil spring may be installed over the rear coil-over shocks 618 and 620, while in other embodiments, two coil springs may be installed over upper and lower portions of the rear coil-over shocks 618 and 620, respectively.

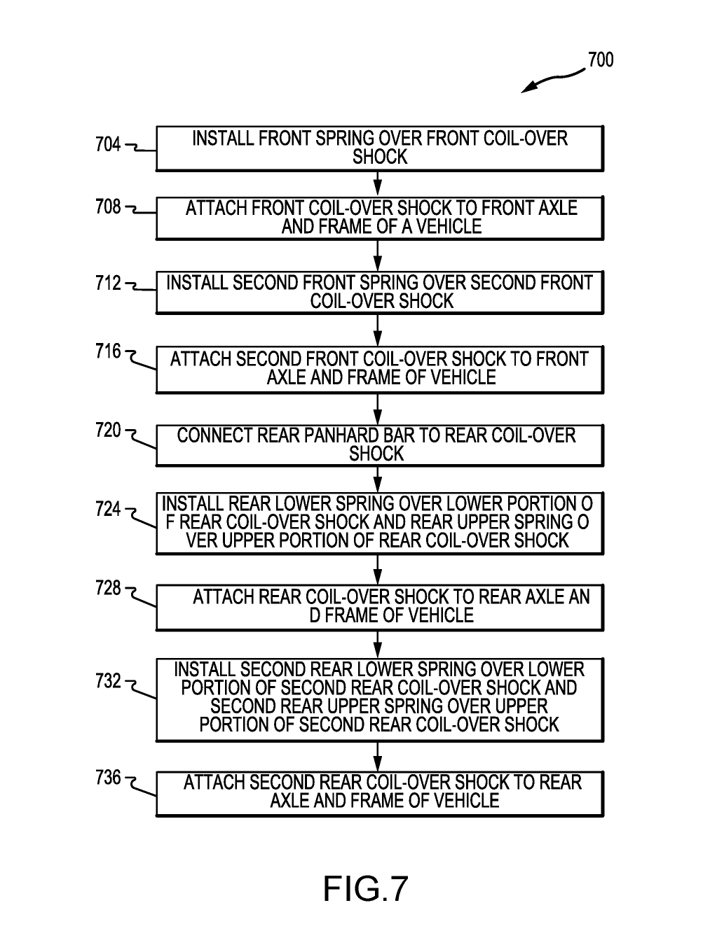

FIG. 7 is flow chart detailing a method 700 of installing a front and rear lift kit (such as the front lift kit 300 and the rear lift kit 400) on a vehicle according to embodiments of the present disclosure. The method 700 comprises installing a front spring over a front coil-over shock (step 704). The front spring may be a coil spring, and may be the same as or similar to any of the coil springs described herein. In some embodiments, a lower front spring may be installed over a lower portion of the front coil-over shock, and an upper front spring may be installed over an upper portion of the front coil-over shock. In such embodiments, the combined length of the lower front spring and the upper front spring may be the same as or similar to the height of a single coil spring that extends over the upper and lower portions of the front coil-over shock.

The method 700 also comprises attaching the front coil-over shock to a front axle of the vehicle and to the frame of the vehicle (step 708). Attaching the front coil-over shock to the front axle of the vehicle may comprise aligning an aperture in a lower end of the front coil-over shock with one or more apertures in a bracket attached to the front axle, and passing a bolt or other fastener through the aperture of the lower end of the front coil-over shock and the one or more apertures in the bracket. The front coil-over shock may be attached to the vehicle frame in a similar manner, but with an upper end of the front coil-over shock having an aperture that is aligned with one or more apertures in a bracket attached to the vehicle frame before a bolt or other fastener is passed through the apertures of the front coil-over shock and the bracket to secure the upper end of the front coil-over shock to the bracket and thus to the vehicle frame. Any method of attachment known in the art may be used to fasten the front coil-over shock to the vehicle front axle and frame.

The method 700 also comprises installing a second front spring over a second front coil-over shock (step 712), and attaching the second front coil-over shock to the front axle and frame of the vehicle (step 716). These steps may be the same as or similar to the steps 704 and 708, respectively.

The method 700 also comprises connecting a rear Panhard bar to a rear coil-over shock. In some embodiments, the rear Panhard bar may be connected to the rear coil-over shock approximately midway along the length of the rear coil-over shock, so as to divide the rear coil-over shock into upper and lower portions roughly equal in length. In other embodiments, the rear Panhard bar may be connected anywhere along the length of the rear coil-over shock, so as to divide the rear coil-over shock into upper and lower portions having different lengths.

The method 700 also comprises installing a rear lower spring over a lower portion of the rear coil-over shock and a rear upper spring over an upper portion of the rear coil-over shock (step 724). In some embodiments, the point of connection of the Panhard bar to the rear coil-over shock determines where the upper portion of the rear coil-over shock ends and the lower portion of the rear coil-over shock begins (or vice versa). In other embodiments, the upper and lower portions may be separated by a mount, a bracket, a washer, or any other suitable structure. Also in some embodiments, only one spring is installed over the rear coil-over shock. In such embodiments, the single spring extends along both upper and lower portions of the rear coil-over spring, rather than just over an upper portion or a lower portion of the rear coil-over spring.

The method 700 also comprises attaching the rear coil-over shock to a rear axle and frame of the vehicle (step 728). Attachment of the rear coil-over shock to the rear axle and frame of the vehicle may be accomplished in the same manner as described above with respect to attachment of the front coil-over shock to the front axle and frame of the vehicle.

The method 700 also comprises installing a second rear lower spring over the lower portion of a second rear coil-over shock, and a second rear upper spring over an upper portion of the second rear coil-over shock (step 732), and attaching the second rear coil-over shock to the rear axle and frame of the vehicle (step 736). These steps may be carried out in the same or in a substantially similar manner as the steps 724 and 728.

The method 700 is not limited to the steps described above, and neither is every step discussed above required for the method 700. In some embodiments, the method 700 may additionally or alternatively comprise: bolting a sway bar to a pair of sway bar end links; connecting a first front arm bar to an upper knuckle; connecting a second front arm bar to a lower knuckle; installing a first rear trailing arm bar into a first trailing arm knuckle; and/or installing a second rear trailing arm bar into a second trailing arm knuckle.

The use of both front coil springs and rear coil springs in a vehicle suspension, as described herein, beneficially improves the handling of the vehicle relative to existing aftermarket suspension systems.

A number of variations and modifications of the foregoing disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

I claim:

1. A lift kit comprising:
a front coil lift kit comprising:
a driver side front coil-over shock and a passenger side front coil-over shock; and
a driver side front coil spring and a passenger side front coil spring; and
a rear coil lift kit comprising:
a driver side rear coil-over shock and a passenger side rear coil-over shock; and
a driver side rear coil spring and a passenger side rear coil spring.

2. The lift kit of claim 1, further comprising a pair of sway bar end links, a sway bar, at least one upper knuckle and at least one lower knuckle, a first front arm bar, a first transfer case, a second front arm bar, and a second transfer case.

3. The lift kit of claim 2, wherein the first front arm bar is between about 25 inches and about 29 inches in length, the second front arm bar is between about 34 inches and about 38 inches in length.

4. The lift kit of claim 1, further comprising a first rear trailing arm bar, a second rear trailing arm bar, and a rear Panhard bar.

5. The lift kit of claim 4, wherein the first rear trailing arm bar is between about 22 inches and about 26 inches in length, the second rear trailing arm bar is between about 34 inches and about 38 inches in length, and the rear Panhard bar is between about 29 inches and about 32 inches in length.

6. The lift kit of claim 1, wherein the driver side front coil spring, the passenger side front coil spring, the driver side rear coil spring, and the passenger side rear coil spring are each about 10-inches or about 12-inches in length.

7. A method of installing a lift kit, the method comprising:
installing a front spring over a front coil-over shock;
attaching the front coil-over shock to a front axle of a vehicle;
connecting a rear Panhard bar to a rear coil-over shock;
installing a rear lower spring over a lower portion of the rear coil-over shock and a rear upper spring over an upper portion of the rear coil-over shock; and
attaching the rear lower coil-over shock and the rear upper coil-over shock to a rear axle of a vehicle.

8. The method of installing a lift kit of claim 7, further comprising:
installing a second front spring over a second front coil-over shock; and
attaching a second front coil-over shock to the front axle of the vehicle.

9. The method of installing a lift kit of claim 8, further comprising:
installing a third rear spring over a second rear coil-over shock; and
attaching the second rear coil-over shock to the rear axle of the vehicle.

10. The method of installing a lift kit of claim 7, wherein installing the front spring over the front coil-over shock comprises installing the front spring over a lower portion of the front coil-over shock and installing an upper front spring over an upper portion of the front coil-over shock.

11. The method of installing a lift kit of claim 10, wherein one of the front spring and the upper front spring is about 10 inches in length.

12. The method of installing a lift kit of claim 7, wherein the rear Panhard bar is about 29.5 inches in length.

13. The method of installing a lift kit of claim 7, wherein the front coil-over shock and the front spring increase a height of a front portion of a frame of the vehicle relative to the front axle of the vehicle, and the rear coil-over shock, the rear lower spring, and the rear upper spring increase a height of a rear portion of a frame of the vehicle relative to the rear axle of the vehicle.

14. A vehicle comprising:
a frame;
a front axle;
a rear axle;
a front coil lift kit comprising:
a driver side front coil-over shock and a passenger side front coil-over shock, the driver side front coil-over shock and the passenger side front coil-over shock each having a first end and a second end, wherein the first end is attached to the frame of the vehicle and the second end is attached to the front axle; and
a pair of front coil springs, one of the pair installed over the driver side front coil-over shock and another of the pair installed over the passenger side front coil-over shock; and
a rear coil lift kit comprising:
a driver side rear coil-over shock and a passenger side rear coil-over shock, the driver side rear coil-over shock and the passenger side rear coil-over shock each having a first end and a second end, wherein the first end is attached to the frame and the second end is attached to the rear axle; and
a pair of rear coil springs, one of the pair of rear coil springs installed over the driver side rear coil-over shock and another of the pair installed over the passenger side rear coil-over shock;
wherein the front coil lift kit and the rear coil lift kit support the frame above the front axle and the rear axle by at least 10 inches.

15. The vehicle of claim 14, further comprising:
a pair of sway bar end links attached to the driver side front coil-over shock and the passenger side front coil-over shock, and a sway bar attached to the pair of sway bar end links;
at least one upper knuckle and at least one lower knuckle attached to the front axle;
a first front arm bar connected to the upper knuckle and a transfer case, the transfer case located on a drive shaft; and
a second front arm bar connected to the lower knuckle and a transfer case.

16. The vehicle of claim 14, further comprising:
a plurality of rear coil springs installed over each of the driver side rear coil-over shock and the passenger side rear coil-over shock.

17. The vehicle of claim 14, wherein the front lift kit is configured to produce at least a minus 4-degree yoke angle, at least a minus 7-degree pinion angle, and at least a minus 3-degree drive shaft angle.

18. The vehicle of claim 14, further comprising:
a plurality of front coil springs installed over each of the driver side front coil-over shock and the passenger side front coil-over shock.

19. The vehicle of claim 14, wherein the front coil lift kit and the rear coil lift kit increase the height of the frame above a ground reference by about 12 to about 14 inches.

20. The vehicle of claim 18, wherein each of the plurality of front coil springs and the plurality of rear coil springs is about 10 inches or about 12 inches in length.
